(19) United States
(12) Patent Application Publication
(10) Pub. No.: US 2024/0281640 A1
(43) Pub. Date: Aug. 22, 2024

(54) NEURAL NETWORK VERIFICATION FOR NEURAL NETWORK CONTROLLERS

(71) Applicant: Toyota Motor Engineering & Manufacturing North America, Inc., Plano, TX (US)

(72) Inventors: Bardh Hoxha, Canton, MI (US); Georgios Fainekos, Novi, MI (US); Tomoya Yamaguchi, Anne Arbor, MI (US); Danil Prokhorov, Canton, MI (US)

(73) Assignees: Toyota Motor Engineering & Manufacturing North America, Inc., Plano, TX (US); Toyota Jidosha Kabushiki Kaisha, Aichi-Ken (JP)

(21) Appl. No.: 18/171,035

(22) Filed: Feb. 17, 2023

(51) Int. Cl. G06N 3/045; G06N 3/0499

(52) U.S. Cl. CPC G06N 3/045; G06N 3/0499

(57) ABSTRACT

Apparatuses, systems, and methods relate to technology to identify temporal logic that is associated with a controller of a physical system simulation, where the controller a first neural network. The technology generates a second neural network based on the temporal logic, and generates, with the second neural network, a robustness metric of the first neural network.

### TECHNICAL FIELD

Examples relate to a neural network verification system that verifies if a neural network controller is performing according to pre-defined specifications. That is, examples relate to a neural network that verifies that temporal specifications defined over a neural network-controlled systems (NNCS) are satisfied.

### BACKGROUND

Neural network controllers may control a variety of automated systems. Therefore, the neural networks controllers may be verified to determine that the neural network controllers are correctly controlling the automated systems. Thus, verifying the operation of neural network controllers has received significant attention. Verification is challenging as system under consideration become increasingly complex as the expressivity of a specification increases (e.g., with an addition of temporal operators).

### BRIEF SUMMARY

A system of one or more computers may be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a testing system. The testing system includes at least one processor, and at least one memory having a set of instructions, which when executed by the at least one processor, causes the testing system to identify temporal logic that is associated with a controller of a physical system simulation, where the controller is a first neural network. The set of instructions, which when executed by the at least one processor, causes the testing system to generate a second neural network based on the temporal logic, and generate, with the second neural network, a robustness metric of the first neural network. Other embodiments of this aspect include corresponding computer systems, apparatus, and computer programs recorded on one or more computer storage devices, each configured to perform the actions of the methods.

One general aspect includes at least one non-transitory computer readable storage medium comprising a set of instructions, which when executed by a computing platform, cause the computing platform to identify temporal logic that is associated with a controller of a physical system simulation, where the controller is a first neural network. The set of instructions, which when executed by the computing platform, cause the computing platform to generate a second neural network based on the temporal logic, and generate, with the second neural network, a robustness metric of the first neural network. Other embodiments of this aspect include corresponding computer systems, apparatus, and computer programs recorded on one or more computer storage devices, each configured to perform the actions of the methods.

One general aspect includes a method that includes identifying temporal logic that is associated with a controller of a physical system simulation, where the controller is a first neural network. The method also includes generating a second neural network based on the temporal logic. The method also includes generating, with the second neural network, a robustness metric of the first neural network. Other embodiments of this aspect include corresponding computer systems, apparatus, and computer programs recorded on one or more computer storage devices, each configured to perform the actions of the methods.

### BRIEF DESCRIPTION OF THE SEVERAL VIEWS OF THE DRAWINGS

The various advantages of the embodiments of the present disclosure will become apparent to one skilled in the art by reading the following specification and appended claims, and by referencing the following drawings, in which:

FIG. 1 is a diagram of an example of an enhanced verification system according to an embodiment;

FIG. 2 is an example of a first algorithm according to an embodiment;

FIG. 3 is a diagram of an example of robustness and STL trees according to an embodiment;

FIG. 4 is a diagram of an example of a Rectified Linear Unit network structure according to an embodiment;

FIG. 5 is a diagram of an example of a robustness tree according to an embodiment;

FIG. 6 is a diagram of an example of a second algorithm according to an embodiment;

FIG. 7 is a diagram of an example of a trapezium FFN network according to an embodiment;

FIG. 8 is a diagram of an example of a first graph according to an embodiment;

FIG. 9 is a diagram of an example of an evolution of states according to an embodiment;

FIGS. 10 and 11 are diagrams of examples of trajectories according to an embodiment;

FIG. 12 is a block diagram of an example of a NNCS verification system according to an embodiment.

### DETAILED DESCRIPTION

Temporal specifications may specify operations of a cyber-physical systems (CPS). A CPS may include a neural network that serves as a controller and a physical system that is controlled by the controller. Temporal specifications may implement closed-loop system properties. Verification that the temporal specifications are being properly implemented may be challenging due to the complexity of the temporal specifications and systems. While verification of neural networks may be considered, existing implementations use input-output specifications where no temporal relations may be specified or verified. Temporal specifications may be necessary for verification of closed-loop system properties and thus, existing implementations are lacking.

Examples build on existing implementation by implementing new and enhanced functionality to verify whether temporal specifications are being met. To do so, examples identify temporal logic that is associated with a controller of a physical system and is associated with a first neural network, generate a second neural network based on the temporal logic, and generate, with the second neural network, a robustness metric of the first neural network. The robustness metric may give a measure of whether the temporal logic is being implemented by the physical system. The second neural network may be appended to the first neural network such that effectively the first and second neural networks merge into a single neural network.

That is, some examples convert a temporal logic specification to a Deep Neural Network (DNN) and then append the DNN to the NNCS. The verification problem (e.g., the temporal logic specification and closed-loop system) is thus represented as a neural network that generates a robustness metric. Such a transformation may implement new functionality to enable verification approaches to be used in the resulting network (e.g., DNN and the NNCS). Neural networks boast several properties that provide particular enhancements for deployment. In particular, neural networks may operate in constant time and space, making neural networks suitable for various forms of computations and analysis, particularly the extensive analysis for validating whether the temporal logic specification is being properly implemented and generating a robustness metric based on the extensive analysis.

Further, examples herein return the robustness of the system with respect to the temporal logic specification. The robustness value (e.g., robustness metric) represents a real number which quantifies how close/far the NNCS is to falsifying the temporal logic specification or satisfying the temporal logic. If the robustness metric is positive, the NNCS satisfies the temporal logic specification (e.g., implements the temporal logic correctly). If the robustness metric is negative, the system falsifies the temporal logic specification (e.g., does not implement the temporal logic specification correctly).

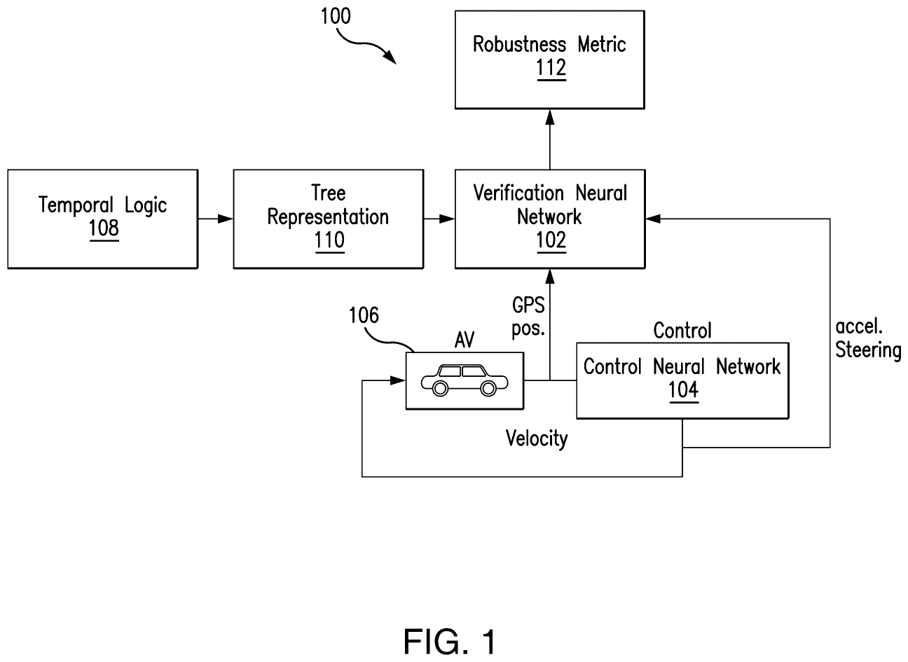

Turning now to FIG. 1, an enhanced verification system 100 (e.g., testing system) is illustrated. The enhanced verification system 100 may be implemented in hardware, circuitry, at least one non-transitory computer readable storage medium comprising a set of instructions, which when executed by a computing platform, cause the computing platform to execute the below described features, etc. In the enhanced verification system 100, an NNCS includes a physical system simulation 106 (e.g., a limited time invariant system) and a control neural network 104 (e.g., a first neural network). The NNCS may be a closed-loop systems where the physical system simulation 106 (e.g., a plant representing the dynamical characteristics of the physical parts of a system), and the control neural network 104 (e.g., a controller) operate with each other. The plant may be controlled. For example, the plant may have an input-output relation. In one example, the plant may be an engine. The physical system simulation 106 may simulate the behavior of a physical system.

The control neural network 104 may employ some specific control law to regulate the behavior of the physical system simulation 106. The physical system simulation 106 may output a position (e.g., Global Positioning System (GPS) location) and a velocity of a vehicle based on a control signal from the control neural network 104. The control neural network 104 may in turn output acceleration and steering commands as the control signal to control the physical system simulation 106 based on the position and the velocity. Each of the physical system simulation 106 and the control neural network 104 may be a DNN. In some examples, the physical system simulation 106 may be a linear time invariant system. The physical system simulation 106 may simulate any type of physical system, such as an autonomous vehicle, industrial system, industrial machinery, robot, etc. In some examples, the physical system simulation may be a real physical system and not a simulation.

The control neural network 104 (e.g., a DNN controller) contains complex non-linear characteristics and as a consequence is challenging to prove that the control neural network 104 is operating safely and robustly to conform with the temporal logic specifications. The urgency for verification increases when the control neural network 104 is designed to satisfy Signal Temporal Logic (STL) specifications. STL specifications may be a particular type of temporal logic specifications. Existing implementations cannot validate that general STL specifications are being correctly implemented.

Thus, examples herein generate the verification neural network 102 (e.g., a second neural network) for verification of the control neural network 104 that implements a general STL specification, and/or the physical system simulation 106. In contrast to existing implementations, the verification neural network 102 is not restricted to verifying if a rectified linear activation function DNN is operating correctly. Examples present a sound and complete verification for a general activation function of the control neural network 104.

To verify the control neural network 104, examples identify the temporal logic 108. The temporal logic 108 (e.g., temporal logic specifications) may be a STL specification. The temporal logic 108 may not be directly translatable into a neural network, and cannot be directly used to verify if the control neural network 104 is operating correctly and within parameters specified in the temporal logic 108. Thus, examples reformulate the temporal logic 108 as a tree representation 110 (e.g., logic tree) and construct the verification neural network 102 (e.g., a Rectified Linear Unit (ReLU) Feed Forward Neural Network (FFNN)) from the tree. For example, the tree representation 110 of the temporal logic correspond to a maximum and minimum number of computations associated with the temporal logic 108. The tree representation 110 may be mapped to the verification neural network 102.

The verification neural network 102 is designed to receive a trajectory from the control neural network 104 and/or the physical system simulation 106 and return the robustness measure of the control neural network 104. For example, the verification neural network 102 may utilize reachability techniques on the control neural network 104 and verify the control neural network 104 given the temporal logic 108. The control neural network 104 may be configured to implement the temporal logic 108, and thus the verification neural network 102 determines whether the control neural network 104 follows the parameters defined in the temporal logic 108.

The reachability analysis technique (algorithm) operates as follows. The reachability analysis technique receives a set or range of inputs, and generates a range or set of all possible outputs. Therefore, the reachability analysis technique not only considers only a single trajectory, the reachability analysis technique considers all possible trajectories generated from a range or set of inputs. Given a set of inputs, a reachability analysis method or a reachability analysis technique determines the set of outputs of a system. If the output set does not intersect with an unsafe set, the system is safe, otherwise the system is unsafe. Several reachability methods may be used. For example, a first method may use a facet-vertex incidence matrix (FVIM) for set propagation. A FVIM is a complete encoding of the combinatorial structure of convex set or a polytope. The FVIM describes the containment relation between facets of a polytope and vertices of the polytope, where facets and vertices are types of faces A second method may be a star-set representation for set propagation. The star set is an efficient set representation for simulation-based verification of large linear systems where the superposition property of a linear system may be exploited in the analysis. Examples have shown] that the star set is also suitable for reachability analysis of FFNNs

For example, the verification neural network 102 may receive a first output from the control neural network 104 and/or the physical system simulation 106, and generate the robustness metric 112 based on the first output. For example, the control neural network 104 may output a control signal to control the physical system simulation 106. The control signal may be provided to the verification neural network 102 to execute the verification of the control neural network 104 and generate the robustness metric 112. In some examples, the control neural network 104 is a continuous time feedback control system.

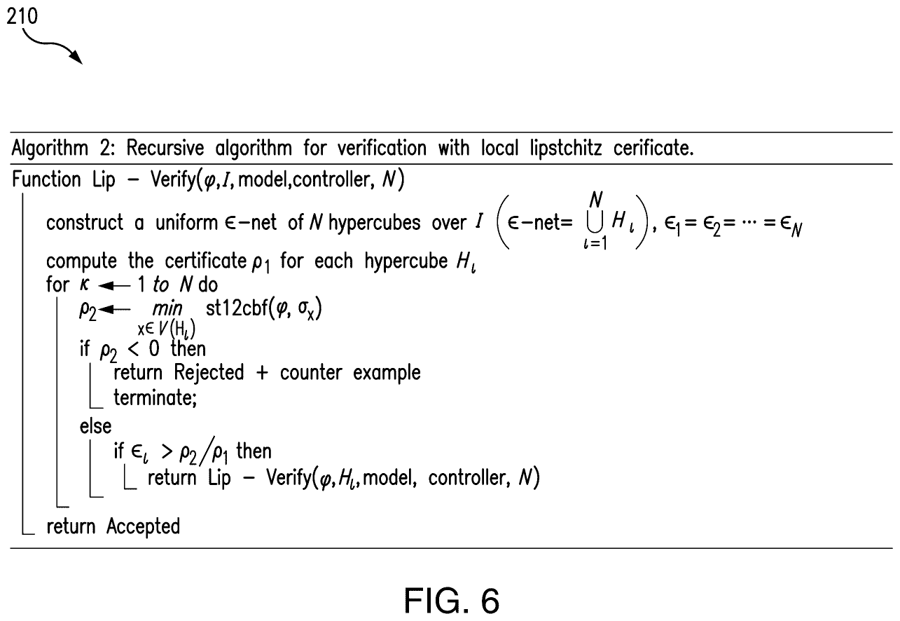

The enhanced verification system 100 can verify if the control neural network 104 satisfies the temporal logic 108 (e.g., correctly implements). If the temporal logic 108 cannot be verified (e.g., failed due to over approximation), examples may execute a Lipschitz constant analysis (discussed below with respect to FIG. 6) to verify that the control neural network 104 implements the temporal logic 108. The Lipschitz constant analysis is a measure of how much a real-valued function of several variables may vary when one of the variables is changed. The Lipschitz constant analysis measures the maximum rate at which the output of the function may change with respect to changes in an input(s) of the function. The Lipschitz constant is defined as the smallest real number, or Lipschitz bound, such that for any two points in the domain, the difference between outputs of the two points is bounded by this number multiplied by the distance between the two points.

In some examples, if the control neural network 104 and if the robustness metric 112 does not meet a threshold, the control neural network 104 may be retrained and retested until the robustness metric 112 does meet the threshold. If the robustness metric 112 does meet the threshold, then the control neural network 104 may be operating correctly and may be propagated to different computing environments to control real-world systems corresponding to the physical system simulation 106. The temporal logic 108 defines one or more of task objectives or safety constraints, and the verification neural network 102 may be a rectified linear activation function Feed Forward Neural Network.

If the control neural network 104 is not a ReLU controller, examples may execute a Lip-Verify which is a sound and complete verification technique. The Lip-Verify technique utilizes a Lipstchitz constant of robustness, a set of initial states and STL-FFNN to verify the control neural network 104.

The below describes a mathematical notation and overall problem definition that is addressed by examples herein. Bold letters indicate vectors and vector-valued functions, and underlined letters denote sets. Let s and u denote the state and input control variables respectively that take values from compact sets S ⊆Rⁿ and C ⊆R^{m}, respectively.

### Examples Consider Nonlinear Feedback Control Systems

$$\dot{s} = \overline{f} ( s , u ( s ) ) \qquad Equation 1$$

where the functions ƒ̅: RRⁿ→RR^{m} may be either a locally Lipschitz continuous ordinary differential equation (ODE) model or a real environment. The sets (RRⁿ and RR^{m}) are the same, but the dimensions of the sets may be different from each other. Examples denote the solutions of Equation 1 over a fixed and compact time interval [t₀, t₁]⊂R≥0 starting at initial state s₀∈I⊆S by x(s₀, t) for t ∈[0, t₁]. Given a control signal from the control neural network 104, u: [t₀, t₁]→C, the trajectory x: S×[t₀, t₁]→RRⁿ is a solution to Equation 1 if x is absolutely continuous in t and x(s₀, t) satisfies Equation 1 for all t ∈[t₀, t₁]. Examples assume a discrete time representation of Equation 1 as a difference equation:

$${s}_{k + 1} = f ( {s}_{k} , u ( {s}_{k} ) ) \qquad Equation 2$$

In equation 2, sampling time tₛ ∈RR_{>0}. Examples consider Equation 2 to be a Lipstchitz bounded feed forward neural network (FFNN) or a linear time variant (LTV) model. For a given initial state s₀∈I⊆S, a system trajectory σₛ₀ is a function from [0,K]⊂Z^{>0} to S, where σₛ₀(0)=s₀, and for all k ∈ [0, K−1], σs₀ (k+1)=f (sₖ, u(sₖ)).

Task Objectives and Safety Constraints are further described as part of the temporal logic 108. Examples assume that task objectives or safety constraints of the system are specified in the temporal logic 108 which may be STL. Examples consider formulas p with syntax defined in Equation 3:

$$ϕ = h ( s ) ⊳ ⊲ 0 \vert ϕ ∧ ϕ \qquad Equation 3$$

### Equation 4 Further Describes STL Equations:

$$φ = {F}_{I} ϕ \vert {G}_{I} ϕ \vert {ϕ}_{1} {U}_{I} {ϕ}_{2} \vert φ ∧ φ \vert φ ∨ φ \qquad Equation 4$$

Equation 4 Equations 3 and 4 may be rules of the temporal logic 108. In Equations 3 and 4, [symbol] ∈ {≤,<,>,≥}, h is a function from S to RR, and I is a closed interval [a, b]⊆[0,K]ϕ denotes signal predicates (or their conjunctions) and φ to STL formulas that contain temporal operators (or their conjunctions). In this example, the subscripts are used to enhance readability, and indicate that two formulas ϕ₁ and ϕ₂ may be connected with the “Until operator.” So, the subscripts may be generated with the same grammar that is defined for ϕ. In Equation 4 (and all equations herein), A denotes a logical conjunction. A logical conjunction is a logical operator that is used to denote a logical AND between two expressions. In Equation 4 (and all equations herein), V represents a logical disjunction. Examples omit the negation operator for signal predicates as the negation operator is redundant.

The formal semantics of STL over discrete-time trajectories are further described. Examples denote the formula ϕbeing true at time k in trajectory σₛ₀ by σₛ₀, k|=ϕ. Examples indicate σₛ₀, k 1=h(s) [symbol] if h(σₛ₀, (k) [symbol] 0; σₛ₀, k|ϕ₁∧ϕ₂ if σₛ₀, k|=ϕ₁ and σₛ₀, k|=ϕ₂. Temporal operators may only range over Boolean combinations of signal predicates, and thus satisfaction of temporal operators may only be defined at time 0. For simplicity, examples omit the time index in the satisfaction relation of temporal operators. Thus, σₛ₀ 1=F_{1ϕ} is true if there exists a time k ∈I where ϕ is true. Similarly, σₛ₀ G₁ ϕ is true if ϕ is true for all k ∈I. Conjunction and disjunction of temporal formulas have various meanings. For a given STL formula ϕᵢ, assume σₛ₀, k|=ϕᵢ. Examples formulate this with a barrier for predicate function as indicated in Equation 5:

$${σ}_{s 0} , k \vert = ϕi ⇐ ⇒ {b}_{ϕ i} ( {s}_{k} , k ) \geq 0 \qquad Equation 5$$

Examples denote the barrier b_{ϕi}(sₖ, k) with (i, k) for simplicity.

Examples perform verification with the verification neural network 102 on the control neural network 104 (e.g., a discrete time feedback control system), and thus prove the feedback controller u(sₖ) satisfies the STL specifications on the discrete model. Examples further utilize this verification and verify the control neural network 104 (e.g., continuous time feedback control system) based on the model properties. A discrete model is assumed to be Lipstchitz bounded FFNN or LTV model.

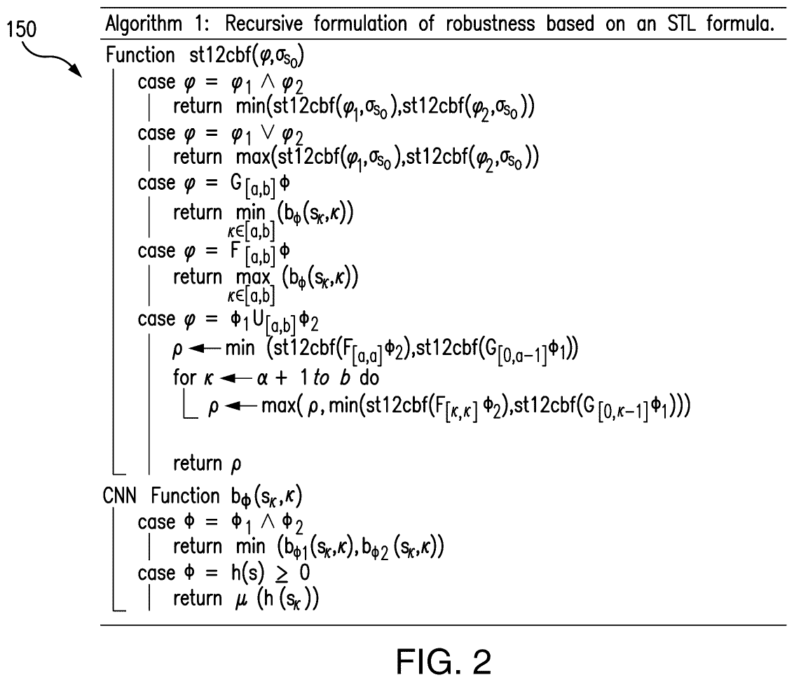

FIG. 2 illustrates a first algorithm 150 for a recursive formulation of robustness based on an STL formula. A robustness of a discrete sequence of states, σₛ₀, is computable with combination of minimum/maximum functions in a recursive fashion. The first algorithm 150 generates the robustness computation. The recursive formula of first algorithm 150 may generate a tree structure that represents STL specifications, where the leaf nodes and parents are the predicates and minimum/maximum functions respectively. As used herein, the tree that represents the STL specifications may be referred to as a STL tree, and the tree for robustness computation may be referred to as a robustness tree.

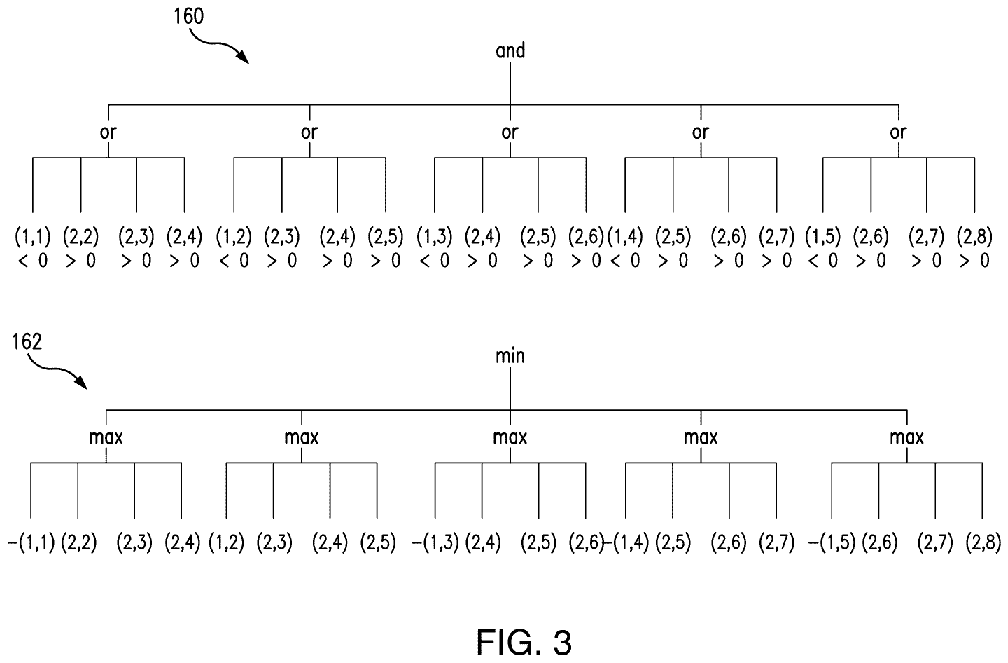

For example, and as illustrated in FIG. 3, consider an adaptive cruise control (ACC), problem. The environment of the ACC is represented with a 6 dimensional state, sk=[x₁(k), x₂(k), x₃(k), x₄(k), x₅(k), x₆(k)]^{T}. In the six dimensional state, the states x₁(k), x₄(k) represent the position for lead and following car respectively at time k, the states x₂(k), x₅(k) represent the velocity for lead car and following car respectively (the following car is behind the lead car) and x₃(k), x₆(k) are hidden states for the dynamics. The relative distance between following and lead cars with dᵣₑₗ(k)=x₁(k)−x₄(k).

In this example, the following vehicle is controlled with a neural network controller. This neural network controller sets the velocity of the following car to maintain on Vₛₑₜ=30 until the following car is in a safe distance from the lead car, dᵣₑₗ>d_{safe}, d_{safe}=10+1.4×5(k). The neural network controller also decelerates the following car once the following car violates the safe zone with the following STL specification:

$$\begin{matrix}{G}_{[ 1 , T ]} ( [ {d}_{rel} < {d}_{safe} ] ⟹ {F}_{[ 1 , 3 ]} [ {d}_{rel} > {d}_{safe}^{*} ] ) , & {d}_{safe}^{*}\end{matrix} = 12 + 1.4 {x}_{5} ( k ) \qquad Equation 6$$

Examples define the predicate ϕ₁ as dᵣₑₗ−d_{safe}>0 and a barrier by b_{ϕ1} (sₖ, k) (1, k)=x₁(k)−x₄(k)−d_{safe}. Examples further define a second predicate ϕ₂ as dᵣₑₗ−d*_{safe}>0 and a barrier of the second predicate by b_{ϕ2} (sₖ, k):=(2, k)=x₁(k) −x₄(k)−d*_{safe}.

FIG. 3 shows the STL tree 160 that represent STL specification, and corresponding robustness tree 162 with T=4. The STL trees 160 and/or robustness tree 162 may be readily substituted for the tree representation 110 (FIG. 1). A minimum of two real numbers a, b may be computed with the following:

$$\begin{matrix}min ( a , b ) = {W}_{2} ReLU ( {W}_{1} [ \begin{matrix}a \\ b\end{matrix} ] ) , & {W}_{2} = [ \begin{matrix}0.5 & - 0.5 & - 0.5 & - 0.5 ] ,\end{matrix} & {W}_{1} = [ \begin{matrix}1 & 1 \\ - 1 & - 1 \\ 1 & - 1 \\ - 1 & 1\end{matrix}\end{matrix} ] \qquad Equation 7$$

The STL tree 160 for STL specification is determined based on Equation 6. The semantics (1, k) represents the barrier of predicate ϕ₁ imposed on the state sₖ. FIG. 3 clarifies the relationship between the STL tree and the recursive formula presented in the first algorithm 150 (FIG. 2) on a specific ACC example. In the above example, W₁ and W₂ are matrices. These specific values may be used to compute min (a,b). For example, if two numbers a,b, are provided, the Equation 7 will return min(a,b)

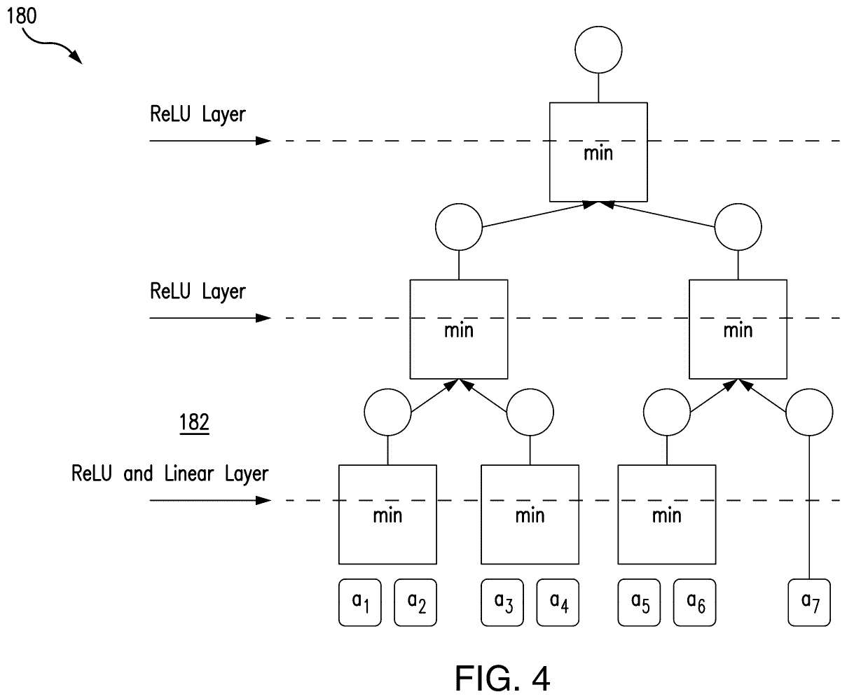

FIG. 4 illustrates an ReLU network structure 180 to find a minimum of 7 variables a₁-a₇. The structure may serve as the basis for a FFNN that computes a minimum value, such as the verification neural network 102 (FIG. 1). For example, the ReLU network structure 180 may be part of the verification neural network 102. The depth of FFNN increases logarithmically with the number of inputs, which in this case is seven a₁-a₇. In such an approach, examples split the set of inputs in the pairs of two. Thereafter, examples apply a minimum ReLU network on each pair and continue the recursive algorithm until the minimum is achieved. The presence of the elements like a₇ which is not involved in minimum computation at the first layer 182, may be processed with a linear activation functions in companion with an ReLU in the first layer 182 since examples construct a unique FFNN that receives all the 7 variables a₁-a₇ and returns the minimum of them.

Equation 8 May Determine the Maximum of the Variables a₁-a₇:

$$\begin{matrix}min ( a , b ) = {W}_{2} ReLU ( {W}_{1} [ \begin{matrix}a \\ b\end{matrix} ] ) , & {W}_{2} = [ \begin{matrix}0.5 & - 0.5 & 0.5 & 0.5 ] ,\end{matrix} & {W}_{1} = [ \begin{matrix}1 & 1 \\ - 1 & - 1 \\ 1 & - 1 \\ - 1 & 1\end{matrix}\end{matrix} ] \qquad Equation 8$$

The above approach for computing the minimum and maximum of two variables may be extended for an arbitrary number of variables. W₂ and W₁ are specific matrices that enable computation of the maximum of two values. The ReLU network structure 180 processes seven elements in a way that the depth of the ReLU network structure 180 increases logarithmically, (e.g., O(log(n)) time), with the number of inputs.

Turning now to FIG. 6, a second algorithm 210 for recursive algorithm for verification with local Lipschitz constant analysis is illustrated. The application of the FFNNs for minimum/maximum computations on the robustness tree results in a unique FFNN that receives the trajectory σₛ₀ from a neural network controller, and returns a robustness of the trajectory σₛ₀. Such a network may be referred to as an STL-FFNN. The STL-FFNN may enhance verification on a general STL specification.

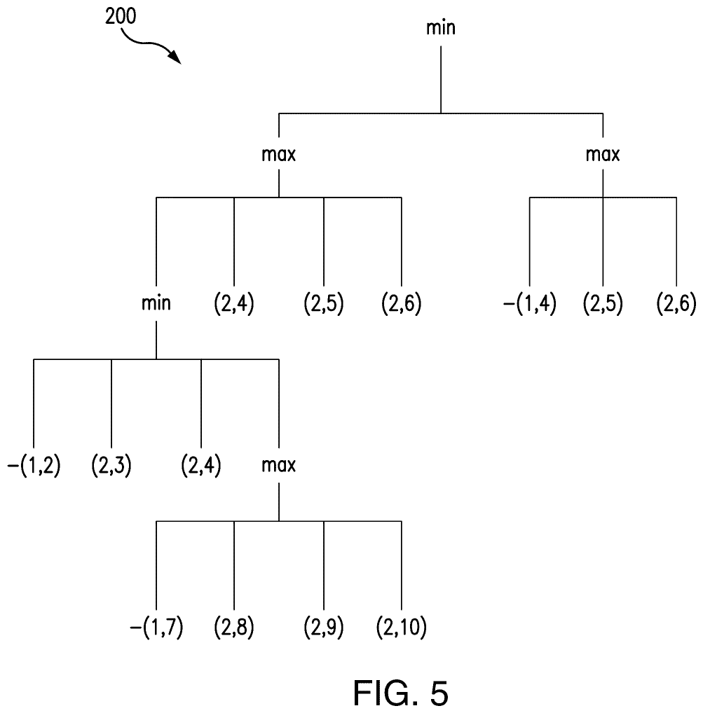

To clarify, consider a robustness tree 200 (FIG. 5). Examples replace the minimum and maximum functions with the FFNNs described with respect to STL tree. This provides a network of ReLU and linear activation functions that receives the barriers of predicates (e.g., leaf nodes) and return the robustness of the trajectory. The deepest leaf nodes are involved in the maximum/minimum computations immediately, but the other leaf nodes are to wait until non-leaf siblings of the other leaf nodes are computed. Doing so does not represent a FFNN but by adding naive linear activation functions, examples generate the STL-FFNN. The FFNN receives all the leaf nodes but only applies the deepest leaves to the nonlinear activations in the beginning. Doing so applies the other leaf nodes to the Linear activations until non-leaf siblings are computed.

As noted, given an STL formula, the depth of STL-FFNN increases logarithmically with the length of the trajectory, σₛ₀. To verify the above, examples identify the number of predicates that are constant and the STL specification is defined. Thus, the number of leaf nodes is of a polynomial order with time horizon K O(K^{P}), where K is the length of the trajectories. The parents in the STL tree have at least two children so that the depth of the tree is O(log(n)), where n is the total number of nodes. The number of total nodes in tree are at most twice the number of leaf nodes. Therefore the depth of the tree is O(log(K^{P}))=O(log(K)). The depth of minimum/maximum FFNNs are logarithmic with respect to the number of inputs. The depth of STL-FFNN is O(log(K)).

The above illustrates a given a complex STL specification, although the width of STL-FFNN may be larger, the depth of the STL-FFNN may not provide inefficiency in gradient computation. Thus the STL-FFNN may be beneficial for motion planning and reinforcement learning in the presence of complex STL specifications.

Examples apply the proposed STL-FFNN to verify a variety of problems with a general STL specification. For example, existing verification techniques may be utilized to find the bounds on the barrier of predicates and bring the STL-FFNN into play for reachability analysis or local Lipstchitz constant computation. Examples first classify the verification problems into two different categories execute a complete verification algorithms for each class. A first category may be all ReLU FFNNs. In the first category, the model is LTV or ReLU FFNN and the controller is also ReLU FFNN. Another category may be a general FFNNs: The model is a non-ReLU FFNN or the controller is also a non-ReLU FFNN.

For the case the model is presented in the form of nonlinear ODE we present sound but not complete verification. The verification with Reachability analysis is presented. In this method, examples mainly focus on the first category to propose sound and complete verification for a general STL specification. We base the verification on star sets that provides exact reachability analysis for ReLU activation function. Examples also present an exact reachability analysis on the trajectories for a feedback control system, which provides exact reachability for sequence of states. Examples can apply this technique and introduce the exact state bounds to STL-FFNN to compute the robustness range through exact star based reachability analysis. This verification is sound and complete. STL-FFNN is a combination of linear (purelin) and ReLU activation functions. This implies STL-FFNN is not a ReLU FFNN, but the exact star set reachability algorithm in may be easily updated to analyze purelin activations and the exact reachability analysis is still doable on STL-FFNN. The exact star based reachability analysis can be time inefficient due to exponential accumulation of star sets through reachability analysis process. In this case we can apply the approximate star based technique to STL-FFNN and verify the controller for a general STL specification.

The verification is sound but it is not complete since it cannot reject the controller such as the control neural network 104 (FIG. 1), due to the consequences. In this case examples refer to the Local Lipstchitz computation algorithm (e.g., presented below) for sound and complete verification.

Reachability analysis for verification is also possible for the second category (General FFNNs). But the verification is not complete since it cannot reject a controller due to the consequent conservatism. Examples refer to Local Lipstchitz computation and techniques for sound and complete verification.

For example, computation of Local Lipstchitz constant for the robustness of STL specifications, stl2cbf(ϕ), with respect to the initial condition, so provides a certificate that allows us to grid the set of initial conditions, I, and verify the controller. This verification is sound and complete, but our results show that the above technique is not applicable on nonlinear ODE models.

Assume L_{loc}, is the local Lipstchiz constant of function f: [ [symbol] ,u]→[a, b] where [symbol] , u ∈Rⁿ and a, b ∈R. We denote the set of all 2ⁿ vertices on [ [symbol] , u] by V([ [symbol] , u]) and examples assume,

$$∀ x ∈ V ( [ ℓ , u ] ) : f ( x ) \geq 0 \qquad Equation 9$$

Given the certificates ρ₁>L_{loc} and

$${ρ}_{2} = {min}_{x ∈ V ( [ ℓ , u ] )} f ( x ) ,$$

examples may verify whether a neural network library may be beneficial. In Equation 9, 1 and u are vectors of size n which define the lower bound and upper bound of the domain for the function f. x is variable which is an element from the set of 2\hat{ }n vertices on [l,u] and ρ₁ is the local Lipstchiz constant.

$${‖ 𝓊 - ℓ ‖}_{2} \leq \frac{{ρ}_{2}}{{ρ}_{1}} ⟹ ∀ x ∈ [ ℓ , u ] : f ( x ) \geq 0 \qquad Equation 10$$

For example, consider x ∈[ [symbol] , u] and x* ∈V([ [symbol] , u]), f(x*)=ρ₂, this implies, ∥x*−x∥2≤∥[u− [symbol] ]∥₂. Examples identify when ρ₁ is an upper bound for the local Lipschitz constant L_{loc}, therefore, Equation 11:

$${‖ {ρ}_{2} - f ( x ) ‖}_{2} \leq {ρ}_{1} {‖ {x}^{*} - x ‖}_{2} \leq {ρ}_{1} {‖ u - ℓ ‖}_{2} = ⟹ {‖ u - ℓ ‖}_{2} \geq \frac{‖ ρ2 - f ( x ) ‖ 2}{ρ 1} \qquad Equation 11$$

Examples assume f(x)<0. Since ρ2 >0, examples may conclude ∥u− [symbol] ∥2>ρ₂/ρ₁ which is a contradiction. The certificate ρ₁, is an upper bound for the local Lipstchitz constant of stl2cbf(φ, σₛ₀) with respect to the initial state, s0 ∈I. If a bounded certificate ρ₁ is accessible, then examples may utilize the notation that L_{loc}, is the local Lip for a sound and complete verification of controllers. In other words, if ρ₁ is accessible (or available), examples provide a method that uses ρᵢ to verify the controller. Based on Equations 9, 10 and 11, examples select an ϵ>0 to build an ϵ-net over the set of initial states. For every single f in the ϵ-net examples compute ρ₂ and check whether ϵ<ρ₂/ρ₁. In case the aforementioned condition, doesn't hold, examples create a finer grid on a hypercube as described herein. Examples terminate the process return the counter example and reject the controller if we ρ2<0. Otherwise examples continue until ϵ<ρ₂/ρ₁ for every single hypercube and verify the neural network controller. Doing so is a recursive process defined in the second algorithm 210.

The efficiency of the above technique is highly related to the tightness of the upper-bound ρ1. For instance, if the upper bound is unreasonably high, an acceptable ϵ tends to infinitesimal numbers resulting in an inefficient verification. Local Lipstchitz computations for neural networks may be enhanced with a variety of techniques. The existing techniques are mostly limited to ReLU activation function. There is also a trade-off between their scalability and accuracy. Regarding these issues, examples focus on convex programming technique since the convex programming is scalable. In addition this approach has shown lower conservatism when a large scale neural network is addressed and there is no limitation regarding the activation function.

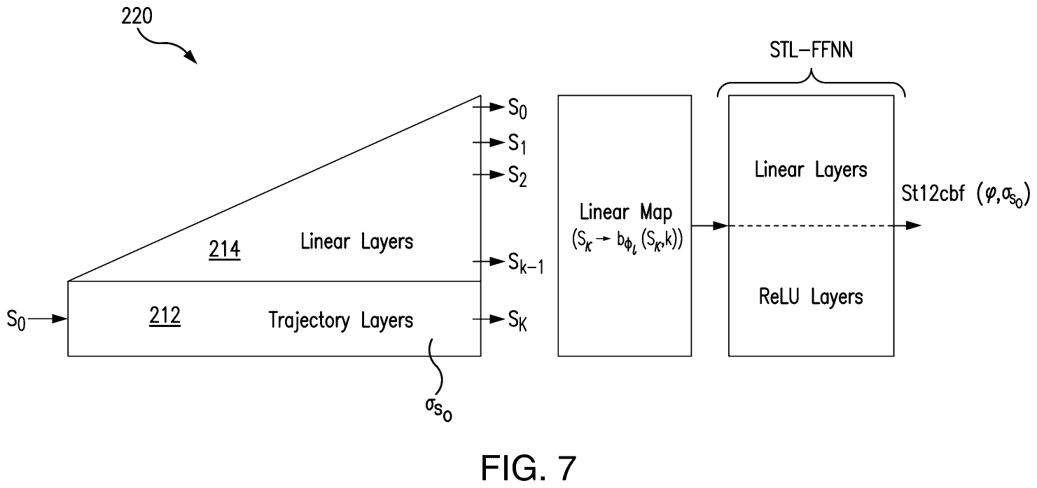

Turning now to FIG. 7, the structure for a trapezium FFFN 220 is illustrated. The trapezium FFFN 220 may generate solutions for problem formulation with reachability and Lipstchitiz constant analysis. The states are transferred to the last layer of trajectory layers 212 with a linear activation function making a Trapezium like structure. To avoid a case specific structure, examples also adjust weight matrices to separate the position of linear and nonlinear activation functions.

Verification for nonlinear ODE models may be possible with approximate reachability techniques. Therefore examples focus on the FFNN or LTV models. Verification problems change based on the STL specification. Thus, examples introduce an applicable and useful structure for the problem formulation.

Such a structure is a Trapezium-FFNN. If examples formulate the problem in the form of Trapezium-FFNN as illustrated in FIG. 7, examples may enjoy a convenient formulation for both star-based reachability analysis and Lipstchitz computation techniques. In this problem formulation, examples consider LTV and FFNN models and may bypass the nonlinear ODE models. The verification for the general STL specification is achievable for the ODE models using STL-FFNN and approximate reachability techniques. In some examples, a single FFNN is generated that receives the initial state, computes the evolution of states over the trajectory and returns the robustness.

The Trapezium FFNN contains two main segments. The first segment of the trapezium FFFN 220 represent the trajectory of states as trajectory layers 212. The second part of the trapezium FFFN 220 includes linear layers 214 (e.g., STL-FFNN). In order to connect the trajectory layers 212 to the linear layers 214, examples may transfer all the states to the last layer of the trajectory layers 212 and connect the states to the linear layers 214 with linear barriers for predicates.

The trajectory layers 212 represent a feedback control system and a part of previously computed states that are to be involved in later computations. Thus, examples transfer the states by adding linear activation functions over the trajectory layers 212. The width of the linear layers 214 increases over the trajectory and provides a trapezium like FFNN shape. The width indicates a number of neurons in a layer. In the start, there are only a few neurons per layer, and as the trajectory size increases, the width of the layers increases proportionally. Furthermore, including linear activation functions imposes no computational complexity for both reachability and lipstchitz constant analysis. Thus, examples provide convenience in star-based reachability analysis. The location of linear and nonlinear activation functions are separated over the trajectory layers, but are mixed over the STL-FFNN. Doing so results in a case specific and difficult formulation.

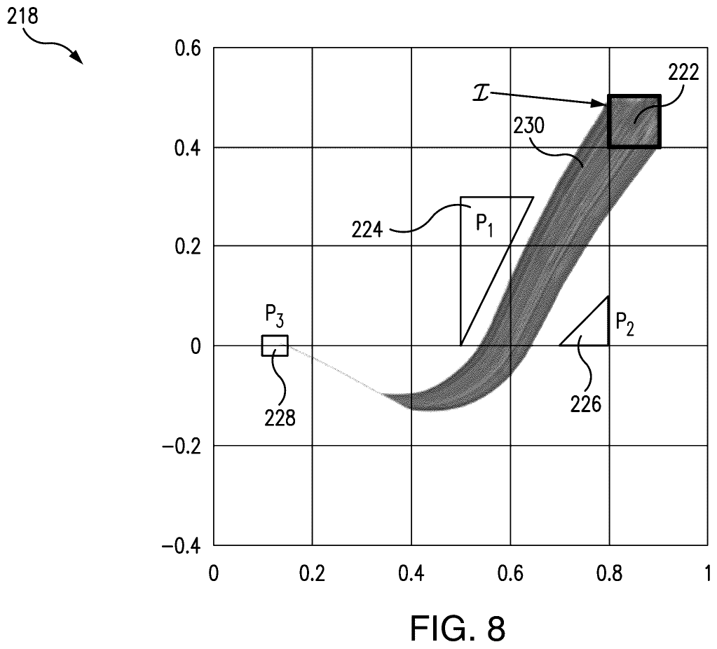

Turning now to FIG. 8, shows a first graph 218 of the evolution of a trajectory 230 of a system. A neural network controller may generate the trajectory 230. A system may originally be at beginning 222 of the trajectory 230. The goal may be for the system to be guided to the end at a third portions 228 without intersecting first section 224 or the second section 226. If the neural network controller guides the system (e.g., through instructions provided to the system) in such a fashion that the system intersects the first section 224 or the second section 226, the neural network controller may be classified by a verification neural network as being not robust. If the neural network controller guides the system (e.g., through instructions provided to the system) in such a fashion that the system does not intersect the first section 224 and the second section 226, the neural network controller may be classified by a verification neural network as being robust.

In some examples, the first graph 218 represents an Advanced Driving Assistance System. Examples applied the approach on several robotics applications. In this example, the dynamics of the system are:

$$[ \begin{matrix}{\dot{x}}_{1} \\ {\dot{x}}_{2}\end{matrix} ] = [ \begin{matrix}- {x}_{1} ( 0.1 + {( {x}_{1} + {x}_{2} )}^{2} ) \\ ( u + {x}_{1} ) ( 0.1 + {( {x}_{1} + {x}_{2} )}^{2} )\end{matrix} ] \qquad Equation 12$$

The specification of the system is:

$$φ = {F}_{[ 75 , 100 ]} [ s ∈ {P}_{3} ] ∧ {G}_{[ 1 , 100 ]} [ s ∉ {P}_{2} ] ∧ {G}_{[ 1 , 100 ]} [ s ∉ {P}_{1} ] \qquad Equation 13$$

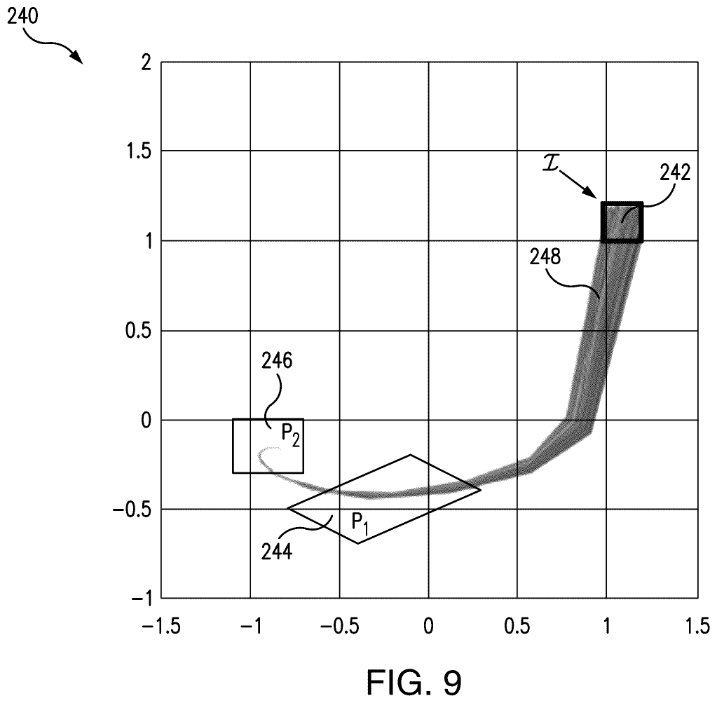

Equation 13 states that “eventually between 75 and 100 seconds, the robot will be in region P3 and always, between 1 and 100 seconds, the robot will not be in P2 and always between 1 and 100 seconds the robot will not be in P1.” FIG. 9 illustrates an evolution of states 240. In this example, the system is at origin 242 and a neural network controller may be instructed to guide the system through the path 248 to the first state 244 and then to second state 246. A verification neural network may generate a robust metric based on how successful the neural network controller is guiding the system through the path 248 to the first state 244 and then to second state 246. The first graph 218 (FIG. 8) and the evolution of states 240 may be generated with different parameters.

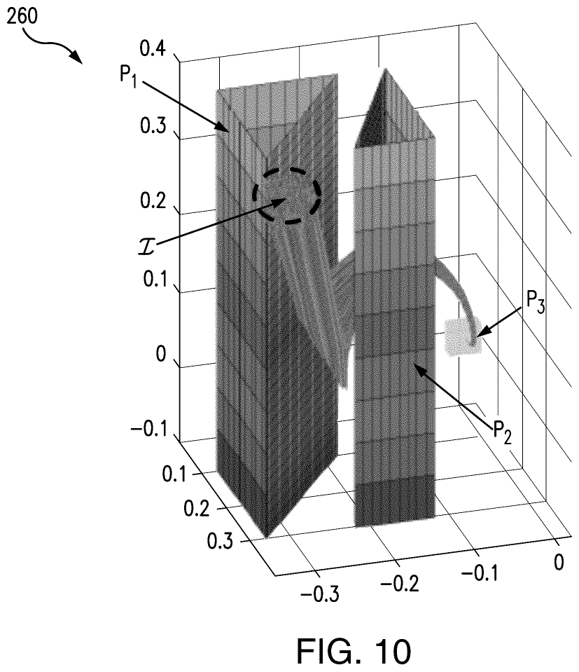

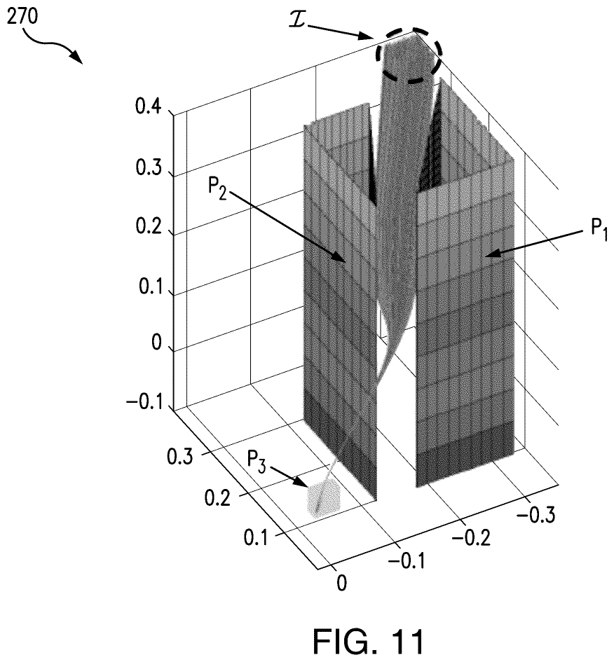

FIGS. 10 and 11 illustrate a represents the trajectories 260, 270 of a FFNN model controlled with another FFNN controller. The FFNN model is trained on the following dynamics:

$$[ \begin{matrix}{\dot{x}}_{1} \\ {\dot{x}}_{2} \\ {\dot{x}}_{3}\end{matrix} ] = [ \begin{matrix}{x}_{1}^{3} + {x}_{2} \\ {x}_{2}^{3} + {x}_{3} \\ u\end{matrix} ]$$

The ReLU activation function, sampling time, ts=0.1 and with dimensions [4, 10, 10, 3]. The controller is also trained to satisfy the STL specifications:

$$φ = {F}_{[ 35 , 50 ]} [ s ∈ {P}_{3} ] ∧ {G}_{[ 1 , 50 ]} [ s ∈ {P}_{2} ] ∧ {G}_{[ 1 , 50 ]} [ s ∈ {P}_{1} ] \qquad Equation 14$$

An ReLU activation function and dimension [3, 100, 1, 2, 1, 2, 1, 1]. Examples attempt to verify the controller satisfies the STL specification for every trajectory of FFNN model started from:

$$ℐ = \{ {s}_{0} \vert [ \begin{matrix}0.35 & - 0.35 & {0.35 ]}^{⊤}\end{matrix} \leq {s}_{0} \leq \begin{matrix}[ 0.4 & - 0.3 & {0.4 ]}^{⊤}\end{matrix} \} \qquad Equation 15$$

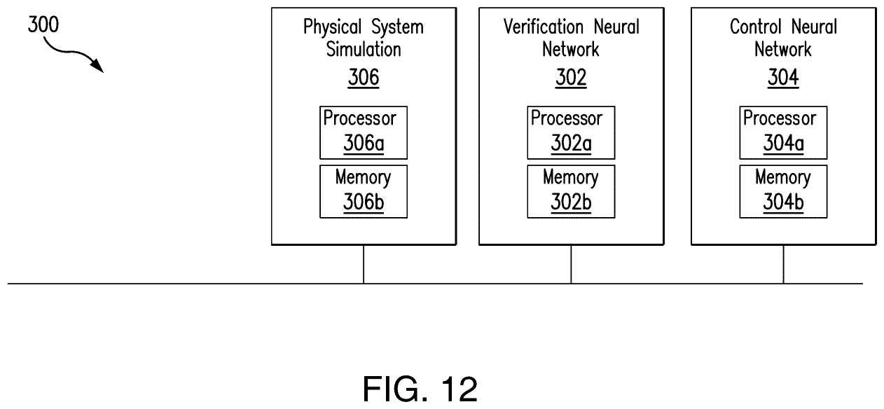

FIG. 12 shows a more detailed example of a NNCS verification system 300 (e.g., a computing platform) to verify if a control neural network 304 operates according to a STL specification. The illustrated system 300 may be readily included in any of the examples described herein.

In the illustrated example, the NNCS verification system 300 may include a physical system simulation 306. As illustrated, the physical system simulation 306 may include a processor 306a (e.g., embedded controller, central processing unit/CPU) and a memory 306b (e.g., non-volatile memory/NVM and/or volatile memory) containing a set of instructions, which when executed by the processor 306a, cause the physical system simulation 306 to simulate a physical system and generate corresponding outputs (e.g., velocity and position of a simulated vehicle).

In the illustrated example, the NNCS verification system 300 may include a control neural network 304. As illustrated, the control neural network 304 may include a processor 304a (e.g., embedded controller, central processing unit/CPU) and a memory 304b (e.g., non-volatile memory/NVM and/or volatile memory) containing a set of instructions, which when executed by the processor 304a, cause the control neural network 304 to generate a control signal (e.g., acceleration and/or steering) to control the simulation of the physical system by the physical system simulation 306.

In the illustrated example, the NNCS verification system 300 may include a verification neural network 302. As illustrated, the verification neural network 302 may include a processor 302a (e.g., embedded controller, central processing unit/CPU) and a memory 302b (e.g., non-volatile memory/NVM and/or volatile memory) containing a set of instructions, which when executed by the processor 302a, cause the verification neural network 302 to generate a robustness metric indicating whether the control neural network 304 satisfies the conditions of the STL specification.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present disclosure can be implemented in a variety of forms. Therefore, while the embodiments of this disclosure have been described in connection with particular examples thereof, the true scope of the embodiments of the disclosure should not be so limited since other modifications will become apparent to the skilled practitioner upon a study of the drawings, specification, and following claims.

We claim:

1. A testing system, comprising:
at least one processor; and
at least one memory having a set of instructions, which when executed by the at least one processor, causes the testing system to:
identify temporal logic that is associated with a controller of a physical system simulation, wherein the controller is a first neural network;
generate a second neural network based on the temporal logic; and
generate, with the second neural network, a robustness metric of the first neural network.

2. The testing system of claim 1, wherein to generate the second neural network, the instructions of the at least one memory, when executed, cause the testing system to:
generate a tree representation of the temporal logic, wherein the tree representation corresponds to a maximum and minimum number of computations associated with the temporal logic; and
map the tree representation to the second neural network.

3. The testing system of claim 1, wherein to generate, with the second neural network, the robustness metric, the instructions of the at least one memory, when executed, cause the testing system to:
receive a first output from the first neural network; and
generate the robustness metric based on the first output from the first neural network.

4. The testing system of claim 3, wherein the instructions of the at least one memory, when executed, cause the testing system to:
control the physical system simulation with the first neural network.

5. The testing system of claim 1, wherein the controller is a continuous time feedback control system.

6. The testing system of claim 1, wherein the instructions of the at least one memory, when executed, cause the testing system to:
verify if the controller satisfies the temporal logic; and
if the controller does not satisfy the temporal logic, execute a Lipschitz constant analysis to verify whether the controller implements the temporal logic.

7. The testing system of claim 1, wherein:
the temporal logic defines one or more of task objectives or safety constraints; and
the second neural network is a rectified linear activation function Feed Forward Neural Network.

8. At least one non-transitory computer readable storage medium comprising a set of instructions, which when executed by a computing platform, cause the computing platform to:
identify temporal logic that is associated with a controller of a physical system simulation, wherein the controller is a first neural network;
generate a second neural network based on the temporal logic; and
generate, with the second neural network, a robustness metric of the first neural network.

9. The at least one non-transitory computer readable storage medium of claim 8, wherein to generate the second neural network, the instructions, when executed, cause the computing platform to:
generate a tree representation of the temporal logic, wherein the tree representation corresponds to a maximum and minimum number of computations associated with the temporal logic; and
map the tree representation to the second neural network.

10. The at least one non-transitory computer readable storage medium of claim 8, wherein to generate, with the second neural network, the robustness metric, the instructions, when executed, cause the computing platform to:
receive a first output from the first neural network; and
generate the robustness metric based on the first output from the first neural network.

11. The at least one non-transitory computer readable storage medium of claim 10, wherein the instructions, when executed, cause the computing platform to:
control the physical system simulation with the first neural network.

12. The at least one non-transitory computer readable storage medium of claim 8, wherein the controller is a continuous time feedback control system.

13. The at least one non-transitory computer readable storage medium of claim 8, wherein the instructions, when executed, cause the computing platform to:
verify if the controller satisfies the temporal logic; and
if the controller does not satisfy the temporal logic, execute a Lipschitz constant analysis to verify whether the controller implements the temporal logic.

14. The at least one non-transitory computer readable storage medium of claim 8, wherein the instructions, wherein:
the temporal logic defines one or more of task objectives or safety constraints; and
the second neural network is a rectified linear activation function Feed Forward Neural Network.

15. A method comprising:
identifying temporal logic that is associated with a controller of a physical system simulation, wherein the controller is a first neural network;
generating a second neural network based on the temporal logic; and
generating, with the second neural network, a robustness metric of the first neural network.

16. The method of claim 15, wherein the generating the second neural network includes:
generating a tree representation of the temporal logic, wherein the tree representation corresponds to a maximum and minimum number of computations associated with the temporal logic; and
mapping the tree representation to the second neural network.

17. The method of claim 15, wherein the generating, with the second neural network, the robustness metric includes:
receiving a first output from the first neural network; and
generating the robustness metric based on the first output from the first neural network.

18. The method of claim 17, further comprising:
controlling the physical system simulation with the first neural network.

19. The method of claim 15, wherein the controller is a continuous time feedback control system.

20. The method of claim 15, further comprising:
verifying if the controller satisfies the temporal logic; and
if the controller does not satisfy the temporal logic, executing a Lipschitz constant analysis to verify whether the controller implements the temporal logic,
wherein the temporal logic defines one or more of task objectives or safety constraints; and
further wherein the second neural network is a rectified linear activation function Feed Forward Neural Network.
